(19) United States
(12) Patent Application Publication
(10) Pub. No.: US 2015/0012265 A1
(43) Pub. Date: Jan. 8, 2015

(54) Enhanced Speech Transmission Index measurements through combination of indirect and direct MTF estimation

(71) Applicants: Sander Jeroen van Wijngaarden, Den Haag (NL); Jan Adrianus Verhave, Bilthoven (NL)

(72) Inventors: Sander Jeroen van Wijngaarden, Den Haag (NL); Jan Adrianus Verhave, Bilthoven (NL)

(21) Appl. No.: 13/933,143

(22) Filed: Jul. 2, 2013

(51) Int. Cl. G10L 19/00

(52) U.S. Cl. CPC G10L 19/00
USPC 704/205

(57) ABSTRACT

The Speech Transmission Index (STI) is an objective measure that predicts speech intelligibility. Test signals are played back through a channel under test. An STI analyzer at the channel output calculates an index between 0 and 1, indicating intelligibility. Over the years, various test signals have been used for measuring the STI, all based on the same principles but differing in the modulation frequencies tested and octave bands covered by the signal. The invention disclosed is a new method for constructing test signals: not just the transfer of modulations on a carrier signal is analyzed, but also the carrier signal itself This apprach leads to more accurate STI measurements that correspond more closely to the ideal (theoretical) STI and to subjective speech intelligibility. Shorter measuring times are achieved without compromising the accuracy of the measurement, while extending the range of systems to which the STI can be reliable applied.

### BACKGROUND

The Speech Transmission Index (STI) is a widely used measure to predict speech intelligibility based on physical measurements (Steeneken and Houtgast, 1980; van Wijngaarden, 2002). The STI method uses an artificial test signal, traditionally consisting of modulated noise, which is presented to the input of a speech transmission channel. An STI analyzer at the output of the channel determines the actual STI, which is an index between 0 and 1. The speech transmission channel can be anything from a radio communication channel to the path between a talker and a listener inside a cathedral.

There are many different hardware devices and software tools that will measure the STI. Mostly, these are straightforward implementations of IEC-60268-16 (2011), the international standard which defines and standardizes the method. Although the standardized STI method was rigorously validated, STI measuring devices are often found to produce results that are disappointing in terms of accuracy and reproducibility. The STI test signals as defined in IEC-60268-16 are based on a random noise carrier, which is deliberately modulated in the intensity domain. Different modulation frequencies are used in different octave bands; standardized test signals differ in the number of octave bands tested and the number of modulation frequencies used per octave band. The most commonly used test signal the so-called STIPA signal, covers 7 octave bands, each simultaneously modulated with 2 modulation frequencies. The RASTI test signal features only 2 octave bands, which are however modulated with 4 resp. 5 modulation frequencies. The ideal configuration consists of 12 modulation frequencies per octave band. Since that many modulation frequencies cannot reliable be modulated (and analyzed) simultaneously, such [symbol] full STI [symbol] measurements require that different modulations are tested consecutively. Full STI measurements are therefore impopular; these take about 15 minutes to complete (compared to 15-25 seconds for STIPA) and testing devices are not (or hardly) available commercially.

There is a procedure, already commonly used by those skilled in the art, to perform measurements that approximate full STI measurements, and to quickly obtain all 12 modulation frequencies per octave band. This so-called [symbol] indirect method [symbol] uses test signals not specifically intended for STI measuring, such as tone sweeps, to measure the impulse response of a channel under test. Theory gives a relation between the impulse response and the modulation transfer function, which is the function from which the STI is calculated (Houtgast, Steeneken and Plomp, 1980). The drawback of this approach is that it cannot be used if the channel under test may feature any form of non-linear distortion or additive noise. These types of distortion violate the assumptions under which the theoretical, mathematical relationship between impulse response and Modulation Transfer Function (and hence the STI) holds. This is why documentation and standards such as IEC-60268-16 warn against using this indirect approach for most applications for which the STI is used in practice, such as assessment of public address systems. Existing art does not cover systems or test signals that allow full STI measurements, universally applicable on channels with any kind of distortion, capable of measuring times less than one minute.

Another issue users of the STI are faced with is the fact that an increasing number of speech transmission systems, such as public address systems or devices used in telephony, feature digital components that are specifically, and exclusively, designed to reproduce real speech. Noise-like artificial signals such as STIPA (defined by IEC 60268-16) are not reproduced at all across such channels, or with a degree of signal quality that is not representative of real speech transmission. Hence, the STI measured using existing art is not reliable when applied to an increasing number of tested systems and channels. This can be circumvented by using real speech as a test signal, as demonstrated by Payton et al. (2002) and Van Gils and Van Wijngaarden (2005). The caveat of STI measurements using real speech as a test signal is that measurements take longer to complete (several minutes), are less accurate, and less robust against non-linear distortion.

### BRIEF DESCRIPTION OF THE DRAWING

FIG. 1 is a block diagram of the enhanced STI measuring system as disclosed here (the STI analyzer, not including the STI test signal generator). The input signal, being the test signal after it has passed through the channel under test, is fed in parallel into three different calculation algorithms. An octave band spectrum is calculated (a), as is common with any implementation of the STI. In parallel, using the direct method as described in IEC 60268-16, the Modulation Transfer Function is calculated (b) using the direct method (MTFd). Also in parallel, the MTF is calculated using the indirect method. For this, synchronization to the test signal is needed, which is achieved by synchronizing to embedded synchronization cues in the test signal (c). Next, the MTFi (indirect method) is calculated (e) by first estimating the impulse response, and from thereon determining the MTF (Houtgast, 1985). Blocks (a)-(e) result in the availability of two MTF estimates: MTFd (which is highly accurate, but sparsely samples in the modulation frequency domain) and MTFi (which may suffer from greater statistical errors and even from systematic measurement errors, but which has greater resolution in the modulation frequency domain). These two are combined (g) by fitting an analytic to MTFi by means of statistical regression, which is then scaled to fit the data points of MTFd. In this manner, an MTF estimate is obtained which has both a high resolution and a high degree of reliability. This MTF estimate is combined with spectral information needed for the STI analyses (f), which is derived from the octave band spectrum (a). Using standardized algorithms, the STI is calculated in the usual fashion (h), resulting in a single STI index (i).

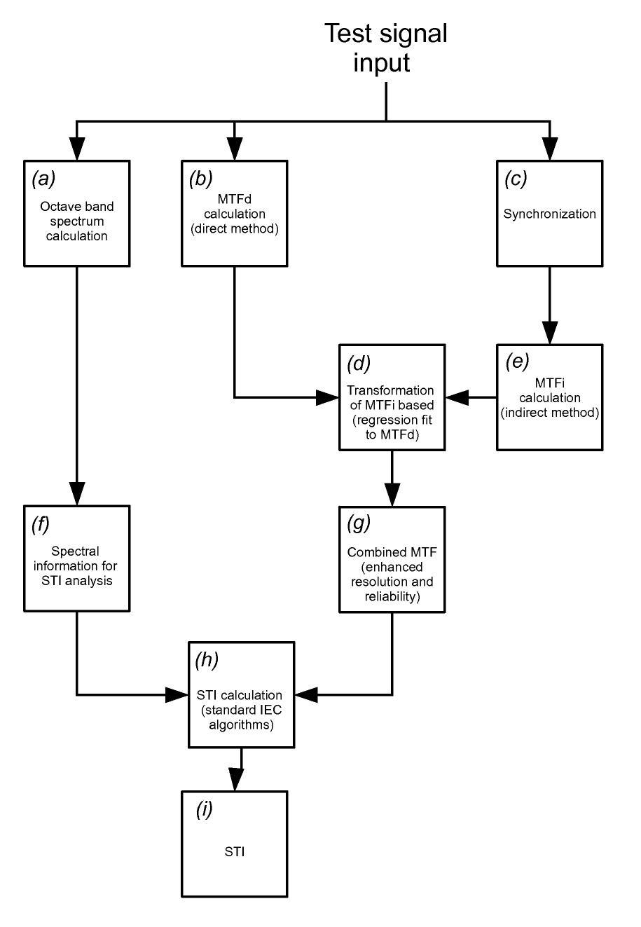

### DETAILED DESCRIPTION

The invention disclosed is a method and apparatus for carrying out STI measurements that outperforms all other currently known methods for measuring the STI in terms of accuracy, reliability and measuring efficiency. The key to the approach is that enhanced test signals are used. These test signals are intensity-modulated according to the procedure described in IEC-60268-16, but differ in terms of the carrier signal. Standard STI test signals (such as STIPA or RASTI) are also intensity modulated, but the carrier signal is always random noise. The disclosed invention comprises test signals using a known, deterministic carrier signal rather than a random noise carrier. This deterministic carrier signal can still be noise-like to the human ear, as is the case with signals such as maximum length sequences. This deterministic carrier is modulated in the same fashion as usual for STIPA measuring systems. After transmission through the channel under test, the processed test signal can now be analyzed in two aspects. The Modulation Transfer Function (MTF) can be estimated directly, by measuring the reduction in modulation depth for each of the applied modulation frequencies in each separate octave band. In addition, the impulse response can be measured from the carrier signal in each octave band. In turn, the Modulation Transfer Function (featuring the entire spectrum of modulation frequencies) can be calculated from this impulse response.

The system now has two estimates of the MTF, one obtained directly (fully reliable, but with few modulation frequencies per band) and one obtained indirectly from the carrier (less reliable, but with the full spectrum of modulation frequencies available). Each MTF function takes the form of a matrix. We will call these MTFd (measured directly from the modulation pattern) and MTFi (measured indirectly from the carrier).

In the STI model, the MTF is a matrix of so-called m-values, for different modulation frequencies between 0.63 and 12.5 Hz, and octave bands between 125 Hz and 8 kHz. How densely or sparsely this matrix is filled may differ, depending on the type of test signal and the version of the STI-model that is used. Also, sound levels are measured in octave bands between 125 Hz and 8 kHz.

The octave band levels and MTF matrix are considered ‘intermediate results’, and are the input for the calculation of the STI index itself. The exact algorithms are standardized in IEC-60268-16.

The matrix MTFd is a sparse (but reliably measured) MTF featuring few m-values per octave band. For instance, when applying the standard modulation scheme used for STIPA, the matrix MTFd features 2 m-values per octave band. The matrix MTFi is a full MTF matrix, filling all combinations of octave band and modulation frequency defined in IEC 60268-16. That means that MTFd contains 12 m-values per octave band.

Before further calculation towards the STI can take place, the two estimates of the MTF matrix, MTFi and MTFd, need to be fused into an overall MTF. The intention is to combine the reliability of the MTFd (two accurate m-values per octave band) with the resolution of the MTFi (multiple less accurate m-values per octave band). This is done through a multiple linear (or fixed-non-linear) regression: per octave band, a regression function is fitted to MTFi. The regression function derived from MTFi is then transformed (re-scaled) using the mean of MTFd per octave band, in such a way that the regression function describes the general behavior of MTFi, but at the mean m-value (per octave band) of MTFd. Finally, this regression function is used to re-synthesize a standard 7×12 MTF matrix, which is converted into an STI value as described in IEC 60268-16.

What makes the scheme presented above challenging to implement is the fact that the carrier signal, due to its deterministic nature, requires synchronization: the STI analyzer must know when exactly the test signal starts. This is not a problem with normal STI measurements using the so-called indirect method, since the duration of the deterministic test signals is short. However, when combined with a modulation scheme to allow a [symbol] dual MTF analysis [symbol] scheme, the duration must be longer: up to 1 minute, as opposed to 1 or 2 seconds. To overcome this synchronization issue, cues are embedded in the carrier signal: short signal (wave) segments of known structure, present at fixed intervals throughout the duration of the test signal, which are translated into a time code by the analyzer. The analyzer only has to search a short segment of the signal to find one of these time codes; it then knows which part of the test signal is currently played back, and adjusts its analysis accordingly.

Apart from the benefits in terms of measurement accuracy, the invention has another major advantage: real human speech can be used as a carrier signal. Although the use of speech as a test signal for STI testing is not new (e.g. Payton et al, 2002), the concept of purposely modulating speech (either real or synthesized) with a known, externally applied modulation pattern, has not been reported before. This is, in fact, a specific implementation of the more general approach described here, for the case that the carrier signal consists of speech. The advantage is that advanced digital speech transmission channels, which are designed to only transmit speech channels, and effectively block out all other signals, will permit the test signal (modulated real-speech) to pass through the channel, permitting an STI test.

1. Method and apparatus for measuring the Speech Transmission Index comprising a test signal constructed from any carrier signal other than random noise, said carier signal being intensity-modulated with one or more modulation frequencies per octave band to result in a modulated carrier signal, which modulated carrier signal is then presented to a speech transmission channel under test, followed at the output of said speech transmission channel by a Speech Transmission Index analyzer performing simultaneous analysis of the transmission quality on said carrier signal as well as on its modulations.

2. System according to claim 1, wherein the impulse response is calculated from said carrier signal and an estimate of the Modulation Transfer Function (MTF) is derived computationally from said impulse response

3. System according to claim 2, comprising a transformation of the Modulation Transfer Function (MTF) measured indirectly from the carrier, the purpose of said transformation being to maximize correspondence between the indirectly measured MTF and the MTF measured directly through the pattern of intensity modulations

4. System according to claim 1, 2 or 3, wherein in said carrier signal contain cues are embedded for synchronization between test signal and analysis apparatus

5. System according to claim 1, 2 or 3, said carrier signal being a maximum length sequence

6. System according to claim 1, 2 or 3, said carrier signal being real human speech

7. System according to claim 1, 2 or 3, said carrier signal being a tone sweep or chirp

8. System according to claim 1, 2 or 3, said carrier signal being a sine wave or complex of sine waves.

9. System according to claim 1, 2 or 3, said carrier signal being a concatenation of synthesized (artificial) or real speech phonemes.
